(19) United States
(12) Patent Application Publication
(10) Pub. No.: US 2025/0331972 A1
(43) Pub. Date: Oct. 30, 2025

(54) ORAL NURSING DEVICE

(71) Applicant: Shenzhen Soocas Technology Co., Ltd., Shenzhen (CN)

(72) Inventor: Fandi MENG, Shenzhen (CN)

(73) Assignee: Shenzhen Soocas Technology Co., Ltd., Shenzhen (CN)

(21) Appl. No.: 19/265,130

(22) Filed: Jul. 10, 2025

Related U.S. Application Data
(63) Continuation of application No. PCT/CN2023/128631, filed on Oct. 31, 2023.

(30) Foreign Application Priority Data
Jan. 13, 2023 (CN) 202320153290.8

(51) Int. Cl. A61C 17/34; A46B 7/04; A46B 11/06; A46B 13/02; A61C 17/22

(52) U.S. Cl. CPC A61C 17/3481; A46B 7/042; A46B 11/063; A46B 13/023; A61C 17/222

(57) ABSTRACT

The present application provides an oral nursing device. The oral nursing device includes: a power output shaft, a clamping groove being arranged in a circumferential side wall of the power output shaft; and a nursing head including: an irrigation-brushing handle provided with a mounting through hole, the mounting through hole being located at a first end of the irrigation-brushing handle; and a mounting structure in limiting fit with the mounting through hole, the mounting structure including a limiting bracket with an internal through hole and a quick detachment bracket in sealing connection with the limiting bracket, the quick detachment bracket being provided with an assembly through hole communicated with the internal through hole, the internal through hole being in rotation stopping fit with the power output shaft, an avoiding groove communicated with the assembly through hole being provided in a circumferential side wall of the quick detachment bracket.

### CROSS-REFERENCE TO RELATED APPLICATIONS

The present application is a continuation of International Application No. PCT/CN2023/128631, filed on Oct. 31, 2023, which claims priority to Chinese Patent Application No. 202320153290.8, entitled “Oral Nursing Device”, filed with China National Intellectual Property Administration on Jan. 13, 2023, the entire content of which is incorporated herein by reference.

### TECHNICAL FIELD

The present application relates to the field of oral nursing technologies, and in particular, to an oral nursing device.

### BACKGROUND

Oral health is important for many people, and as an existing oral cleaning mode on the market, generally, the oral cavity is irrigated by an oral irrigator alone, or teeth are brushed by an electric toothbrush alone, or an electric toothbrush is externally connected with a conduit to be connected with a water tank of an oral irrigator. The electric toothbrush has the working principle of high-frequency vibrations, and the oral irrigator has the working principle that a nozzle sprays water to the oral cavity. That is, the electric toothbrush only considers vibration transmission and does not consider separation of a motor shaft caused by a water pressure impact force, and the oral irrigator only considers the separation of the motor shaft caused by the water pressure impact force and does not consider the vibration transmission.

An irrigation-brushing all-in-one machine can generally satisfy the transmission of the high-frequency vibration and fixation under the water pressure impact force, so as to cause an oral nursing device to have a synchronous irrigation-brushing function. However, on the one hand, in order to save a placing space and a using cost, and since a nursing head should be dedicated due to involvement of personal hygiene, the nursing head needs to be replaced; on the other hand, the nursing head may be worn in use and needs to be replaced in time; thus, a user may frequently assemble and disassemble the nursing head to replace the nursing head in time.

In the prior art, a structure of the oral nursing device for connecting a power output shaft and a mounting structure of the nursing head is complicated, which may lead to a tedious disassembly and assembly process of an irrigation-brushing handle, resulting in low use experience of the user.

### SUMMARY

A main object of the present application is to provide an oral nursing device which can realize quick disassembly and assembly of a nursing head to facilitate a user to replace the nursing head.

In order to achieve the above object, the present application provides an oral nursing device, including a handle portion and a nursing head, the handle portion being configured to be gripped, the handle portion including: a motor including a motor body and a power output shaft, the power output shaft being configured to be fitted with the motor body and transmit output power of the motor body, an axial passage extending along an axis of the power output shaft being arranged on the power output shaft, and a clamping groove being arranged in a circumferential side wall of the power output shaft; the nursing head including: an irrigation-brushing handle provided with a fluid passage extending along the axis of the power output shaft and a mounting through hole communicated with the fluid passage, the axial passage being communicated with the fluid passage, and the mounting through hole being located at a first end of the irrigation-brushing handle; a brush head arranged at a second end of the irrigation-brushing handle, the brush head including bristles and a spray head, a direction of a nozzle of the spray head being the same as that of the bristles, and the spray head being communicated with the fluid passage; a mounting structure located in the mounting through hole and in limiting fit with the mounting through hole, the mounting structure including a limiting bracket with an internal through hole and a quick detachment bracket in sealing connection with the limiting bracket, the quick detachment bracket being located on a side of the limiting bracket opposite to the brush head, the quick detachment bracket being provided with an assembly through hole communicated with the internal through hole, the internal through hole being in rotation stopping fit with the power output shaft, the power output shaft penetrating through the assembly through hole, an avoiding groove communicated with the assembly through hole being provided in a circumferential side wall of the quick detachment bracket, the mounting structure further including a clamping member located in the avoiding groove, a connecting end of the clamping member being connected with the quick detachment bracket, and a free end of the clamping member extending into the assembly through hole through the avoiding groove and being in clamping fit with the clamping groove in the power output shaft.

Further, the clamping member includes a connecting arm and a clamping protrusion which are connected and arranged at an included angle, the connecting arm extends in a direction parallel to the power output shaft, the clamping protrusion protrudes in a direction of an axis of the assembly through hole, an end of the connecting arm away from the clamping protrusion forms the connecting end, and an end of the clamping protrusion away from the connecting arm forms the free end.

Further, a first guide surface is obliquely arranged on the clamping protrusion, the first guide surface is located on a side of the clamping protrusion opposite to the connecting end, and along an axial direction of the power output shaft, a distance between the first guide surface and the axis of the assembly through hole is gradually reduced from an end of the quick detachment bracket away from the limiting bracket to an end of the quick detachment bracket close to the limiting bracket.

Further, a second guide surface is obliquely arranged on the clamping protrusion, the second guide surface is located on a side of the clamping protrusion facing the connecting end, and along the axial direction of the power output shaft, a distance between the second guide surface and the axis of the assembly through hole is gradually increased from the end of the quick detachment bracket away from the limiting bracket to the end of the quick detachment bracket close to the limiting bracket.

Further, a circumferential side wall of the limiting bracket is provided with an assembly through groove communicated with the internal through hole, the mounting structure further includes an elastic arm located in the assembly through groove and dividing the assembly through groove into two parts, the elastic arm extends in a direction parallel to an axial direction of the internal through hole, and the elastic arm is configured to be deformable in a radial direction of the internal through hole.

Further, the clamping groove is an annular groove arranged around the axis of the power output shaft; or an included angle between the connecting arm and the clamping protrusion is greater than or equal to 45 degrees and less than or equal to 90 degrees.

Further, the nursing head further includes a limiting groove arranged in an inner wall of the mounting through hole and a limiting rib arranged on the quick detachment bracket, the limiting groove is arranged around an axis of the mounting through hole, and the limiting rib is in limiting fit with the limiting groove.

Further, the nursing head further includes a directional groove and a directional rib fitted with the directional groove, the directional groove is arranged in one of the inner wall of the mounting through hole and the quick detachment bracket, and the directional rib is arranged on the other of the inner wall of the mounting through hole and the quick detachment bracket.

Further, the nursing head further includes two rotation stopping ribs located in the mounting through hole and connected with the inner wall of the mounting through hole, and the two rotation stopping ribs are spaced apart along a circumferential direction of the mounting through hole; along the circumferential direction of the mounting through hole, two rotation stopping grooves are spaced apart in the limiting bracket, a spacing structure between the two rotation stopping grooves forms a convex rib, and the convex rib is inserted between the two rotation stopping ribs.

Further, a positioning groove is arranged in a circumferential side of the power output shaft, a positioning convex rib is arranged on an inner wall of the internal through hole, the positioning convex rib is connected with the limiting bracket, and the positioning convex rib is fitted with the positioning groove.

By applying the technical solution of the present application, the power output shaft penetrates through the assembly through hole, the circumferential side wall of the quick detachment bracket is provided with the avoiding groove communicated with the assembly through hole, the clamping member is located in the avoiding groove, the connecting end of the clamping member is connected with the quick detachment bracket, the free end of the clamping member extends into the assembly through hole through the avoiding groove and is in clamping fit with the clamping groove in the power output shaft, and thus, one end of the clamping member is connected with the quick detachment bracket, and the rest of the clamping member is suspended in the avoiding groove and the assembly through hole, such that the clamping member can have a certain deformation capacity to generate an elastic effect, and therefore, when the power output shaft is inserted into the assembly through hole of the quick detachment bracket, the clamping member can be elastically deformed until the free end of the clamping member is clamped into the clamping groove in the power output shaft, and the clamping member is recovered from deformation, thereby realizing rapid mounting of the nursing head and the power output shaft; similarly, since the clamping member can have a certain elastic deformation capacity, when the user disassembles the nursing head, the clamping member can be elastically deformed to be separated from the clamping groove in the power output shaft, such that the user can remove the nursing head by gripping the handle portion to directly pull out the power output shaft, thereby realizing rapid disassembly of the nursing head to improve use experience of the user.

### BRIEF DESCRIPTION OF THE DRAWINGS

The accompanying drawings constituting a part of the present application are intended to provide a further understanding of the present application, and the schematic embodiments of the present application and descriptions thereof are intended to illustrate the present application and do not improperly limit the present application. In the drawings:

FIG. 1 shows a schematic structural diagram of an embodiment of an irrigation-brushing handle of an oral nursing device according to the present application;

FIG. 2 shows a schematic exploded structural diagram of an embodiment of a nursing head of the oral nursing device according to the present application;

FIG. 3 shows a schematic structural diagram of a limiting bracket of the nursing head of FIG. 2;

FIG. 4 shows a sectional view of the limiting bracket of FIG. 3;

FIG. 5 shows a schematic structural diagram of the limiting bracket of the nursing head of FIG. 2;

FIG. 6 shows a sectional view of a quick detachment bracket of FIG. 5;

FIG. 7 shows another schematic exploded structural diagram of the embodiment of the nursing head of the oral nursing device according to the present application; and

FIG. 8 shows a schematic structural diagram of the oral nursing device according to an embodiment of the present application.

The drawings include the following reference numerals:

01. handle portion; 02. nursing head; 10. irrigation-brushing handle; 11. fluid passage; 12. mounting through hole; 13. bristle; 14. spray head; 20. limiting bracket; 21. assembly through groove; 22. elastic arm; 23. rotation stopping rib; 24. rotation stopping groove; 25. first convex rib; 30. quick detachment bracket; 31. avoiding groove; 32. clamping member; 321. connecting arm; 322. clamping protrusion; 323. first guide surface; 324. second guide surface; 33. limiting groove; 34. limiting rib; 35. directional groove; 36. directional rib; 38. positioning convex rib; 39. assembly through hole; 40. brush head; 41. mounting structure; 42. internal through hole; 50. sound wave motor; 51. motor body; 52. power output shaft; 521. axis; 522. axial passage; 523. clamping groove.

### DETAILED DESCRIPTION

It should be noted that the embodiments in the present application and features in the embodiments may be combined with each other without conflicts. The present application is described in detail below with reference to the accompanying drawings in conjunction with embodiments.

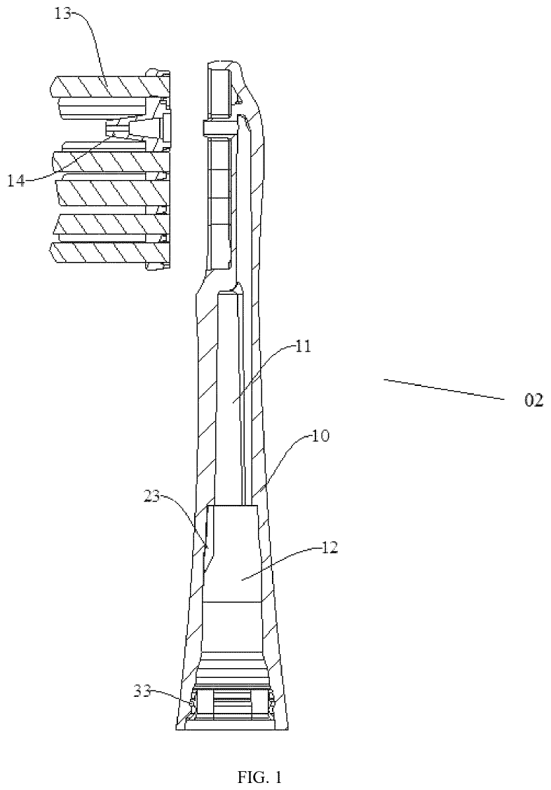

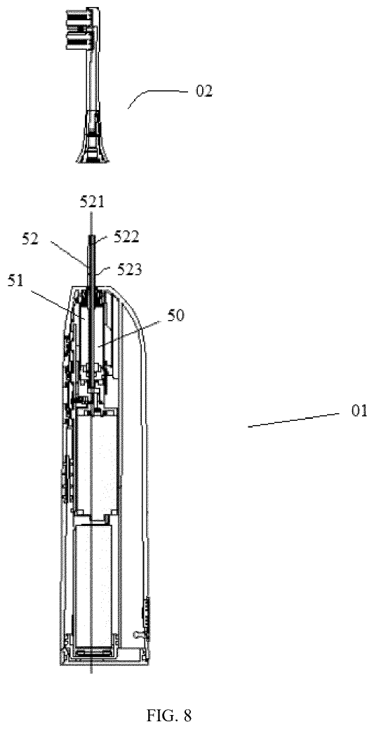

As shown in FIGS. 1 to 6 and 8, embodiments of the present application provide an oral nursing device. The oral nursing device includes a handle portion 01 and a nursing head 02, the handle portion being configured to be gripped, the handle portion including a sound wave motor 50 including a motor body 51 and a power output shaft 52, the power output shaft being configured to be fitted with the motor body and transmit output power of the motor body, an axial passage 522 extending along an axis 521 of the power output shaft being arranged on the power output shaft, and a clamping groove 523 being arranged in a circumferential side wall of the power output shaft. The nursing head includes an irrigation-brushing handle 10, a brush head 40, and a mounting structure 41. The irrigation-brushing handle 10 is provided with a fluid passage 11 extending along the axis of the power output shaft and a mounting through hole 12 communicated with the fluid passage 11, the axial passage is communicated with the fluid passage 11, and the mounting through hole 12 is located at a first end of the irrigation-brushing handle 10; the brush head is arranged at a second end of the irrigation-brushing handle 10, the brush head includes bristles 13 and a spray head 14, a direction of a nozzle of the spray head 14 is the same as that of the bristles 13, and the spray head 14 is communicated with the fluid passage 11; the mounting structure is located in the mounting through hole 12 and in limiting fit with the mounting through hole 12, the mounting structure includes a limiting bracket 20 with an internal through hole 42 and a quick detachment bracket 30 in sealing connection with the limiting bracket 20, the quick detachment bracket 30 is located on a side of the limiting bracket 20 opposite to the brush head, the quick detachment bracket 30 is provided with an assembly through hole 39 communicated with the internal through hole, the internal through hole is in rotation stopping fit with the power output shaft, the power output shaft penetrates through the assembly through hole 39, an avoiding groove 31 communicated with the assembly through hole 39 is provided in a circumferential side wall of the quick detachment bracket 30, the mounting structure further includes a clamping member 32 located in the avoiding groove 31, a connecting end of the clamping member 32 is connected with the quick detachment bracket 30, and a free end of the clamping member 32 extends into the assembly through hole 39 through the avoiding groove 31 and being in clamping fit with the clamping groove in the power output shaft.

In the above technical solution, the power output shaft penetrates through the assembly through hole 39, the circumferential side wall of the quick detachment bracket 30 is provided with the avoiding groove 31 communicated with the assembly through hole 39, the clamping member 32 is located in the avoiding groove 31, the connecting end of the clamping member 32 is connected with the quick detachment bracket 30, the free end of the clamping member 32 extends into the assembly through hole 39 through the avoiding groove 31 and is in clamping fit with the clamping groove in the power output shaft, and thus, one end of the clamping member 32 is connected with the quick detachment bracket 30, and the rest of the clamping member 32 is suspended in the avoiding groove 31 and the assembly through hole 39, such that the clamping member 32 can have a certain deformation capacity to generate an elastic effect, and therefore, when the power output shaft is inserted into the assembly through hole 39 of the quick detachment bracket 30, the clamping member 32 can be elastically deformed until the free end of the clamping member 32 is clamped into the clamping groove in the power output shaft, and the clamping member 32 is recovered from deformation, thereby realizing rapid mounting of the nursing head and the power output shaft; similarly, since the clamping member 32 can have a certain elastic deformation capacity, when a user disassembles the nursing head, the clamping member 32 can be elastically deformed to be separated from the clamping groove in the power output shaft, such that the user can remove the nursing head by gripping the handle portion to directly pull out the power output shaft, thereby realizing rapid disassembly of the nursing head to improve use experience of the user.

Further, in the present embodiment, on the one hand, the internal through hole of the limiting bracket 20 is in rotation stopping fit with the power output shaft, and the mounting structure is located in the mounting through hole 12 and in limiting fit with the mounting through hole 12, such that the power output shaft can transmit a driving force to the irrigation-brushing handle 10 through the limiting bracket 20 to ensure that a vibration is transmitted to the irrigation-brushing handle 10, thereby realizing the function of cleaning teeth of an electric toothbrush by using the vibration of the sound wave motor; on the other hand, the power output shaft penetrates through the assembly through hole 39 of the quick detachment bracket 30, the clamping member 32 connected with the quick detachment bracket 30 is in clamping fit with the clamping groove in the power output shaft, and the mounting structure is located in the mounting through hole 12 and in limiting fit with the mounting through hole 12, and thus, an axial displacement of the power output shaft relative to the irrigation-brushing handle 10 can be limited, and the problem of separation of the power output shaft from the irrigation-brushing handle 10 caused by a water pressure impact force can be avoided, so that a swing force transmitted by the power output shaft can be more stably transmitted to the irrigation-brushing handle 10, and therefore, the oral nursing device according to the present embodiment has the tooth brushing function of the electric toothbrush and an irrigation function of an oral irrigator, so as to improve the experience of the user and a cleaning effect of the oral nursing device. Therefore, the oral nursing device according to the present embodiment has a synchronized irrigation-brushing function.

It should be noted that, in the embodiment of the present application, the limiting fit of the mounting structure and the mounting through hole 12 refers to a radial limiting fit and an axial limiting fit of the mounting structure and the mounting through hole 12.

For a mounting structure of an oral nursing device known by the inventor, the irrigation-brushing handle is loosely fixed and prone to fall off in use, and in the present embodiment, the mounting structure can be more compact through the limiting bracket 20 and the quick detachment bracket 30 which are in sealing connection, such that the irrigation-brushing handle can be more stably mounted.

Specifically, as shown in FIG. 1, in the embodiment of the present application, an inner diameter of the mounting through hole 12 is larger than an inner diameter of the fluid passage 11, such that a stepped surface may be formed between the fluid passage 11 and the mounting through hole 12 to limit the limiting bracket 20.

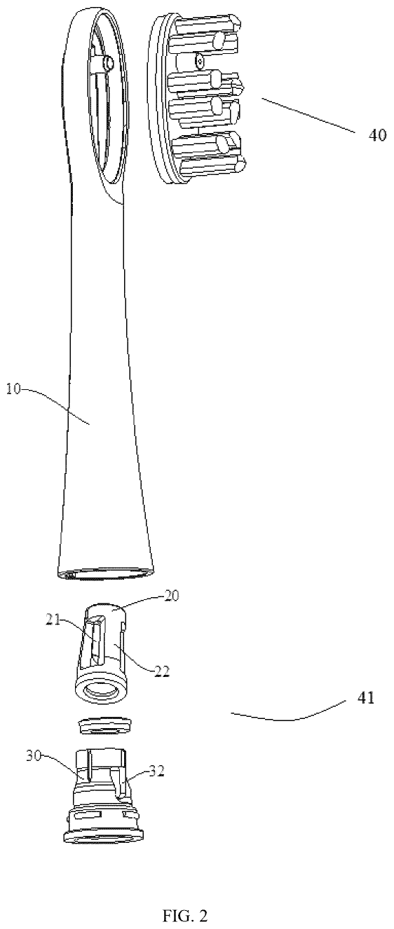

As shown in FIG. 2, in the embodiment of the present application, the mounting structure further includes an annular seal between the limiting bracket 20 and the quick detachment bracket 30. Thus, a space between the limiting bracket 20 and the quick detachment bracket 30 can be sealed, thereby preventing water leakage between the limiting bracket 20 and the quick detachment bracket 30.

Preferably, the annular seal includes an annular wall, an annular groove is formed in an end surface of the annular wall, and an opening of the annular groove is arranged towards the limiting bracket 20, such that when the power output shaft is mounted, an inner hole side wall of the annular wall is pressed, the annular groove may contract, and therefore, the power output shaft is convenient to mount. The larger the water pressure in the fluid passage 11 is, the larger the expanding degree of the annular groove after the annular groove is subjected to the water pressure is, the tighter the wrapping of the power output shaft is, and the better the sealing effect between the side wall of the annular wall and an inner wall of the mounting through hole is, thereby preventing the water leakage between the limiting bracket 20 and the quick detachment bracket 30.

In an embodiment, the annular seal is a Y-shaped sealing ring.

In alternative embodiments, the annular seal may be an O-shaped sealing ring, or the limiting bracket 20 may be formed integrally with the sealing ring.

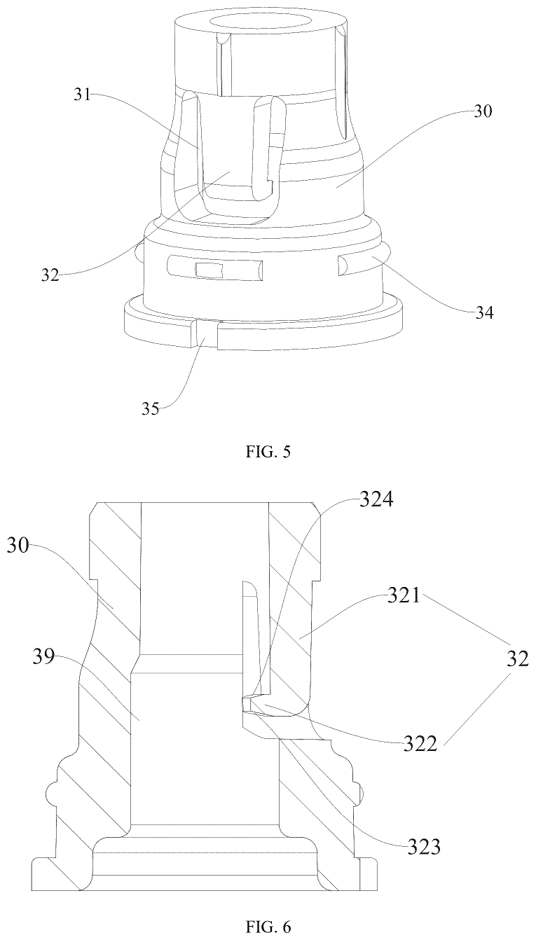

As shown in FIGS. 5 and 6, in the embodiment of the present application, the clamping member 32 includes a connecting arm 321 and a clamping protrusion 322 which are connected and arranged at an included angle, the connecting arm 321 extends in a direction parallel to the power output shaft, the clamping protrusion 322 protrudes in a direction of an axis of the assembly through hole 39, an end of the connecting arm 321 away from the clamping protrusion 322 forms the connecting end, and an end of the clamping protrusion 322 away from the connecting arm 321 forms the free end.

With the above arrangement, one end of the connecting arm 321 is connected with the quick detachment bracket 30, and the rest of the connecting arm 321 can be suspended in the avoiding groove 31, such that the connecting arm 321 has certain elasticity, and when the power output shaft is dismounted, the connecting arm 321 can be deformed to enable the clamping protrusion 322 to be quickly in clamping fit with or released from the fit with the clamping groove, so as to realize quick dismounting and mounting between the power output shaft and the nursing head.

As shown in FIG. 6, in the embodiment of the present application, a first guide surface 323 is obliquely arranged on the clamping protrusion 322, the first guide surface 323 is located on a side of the clamping protrusion 322 opposite to the connecting end, and along an axial direction of the power output shaft, a distance between the first guide surface 323 and the axis of the assembly through hole 39 is gradually reduced from an end of the quick detachment bracket 30 away from the limiting bracket 20 to an end of the quick detachment bracket 30 close to the limiting bracket 20.

With the above arrangement, when the power output shaft is inserted into the assembly through hole 39, the first guide surface 323 can guide the power output shaft, such that the power output shaft can be inserted into the assembly through hole more smoothly, and the first guide surface 323 can make the power output shaft more easily press the clamping protrusion 322 to deform the clamping member 32 in a radial direction of the assembly through hole 39 in a direction away from the power output shaft, thereby facilitating mounting of the nursing head on the power output shaft.

As shown in FIG. 6, in the embodiment of the present application, a second guide surface 324 is obliquely arranged on the clamping protrusion 322, the second guide surface 324 is located on a side of the clamping protrusion 322 facing the connecting end, and along the axial direction of the power output shaft, a distance between the second guide surface 324 and the axis of the assembly through hole 39 is gradually increased from the end of the quick detachment bracket 30 away from the limiting bracket 20 to the end of the quick detachment bracket 30 close to the limiting bracket 20.

In the above technical solution, when the user pulls out the power output shaft from the assembly through hole 39, the second guide surface 324 can play a guiding role, such that the clamping protrusion 322 can be more easily separated from the clamping groove of the power output shaft, thereby facilitating detachment of the nursing head from the power output shaft.

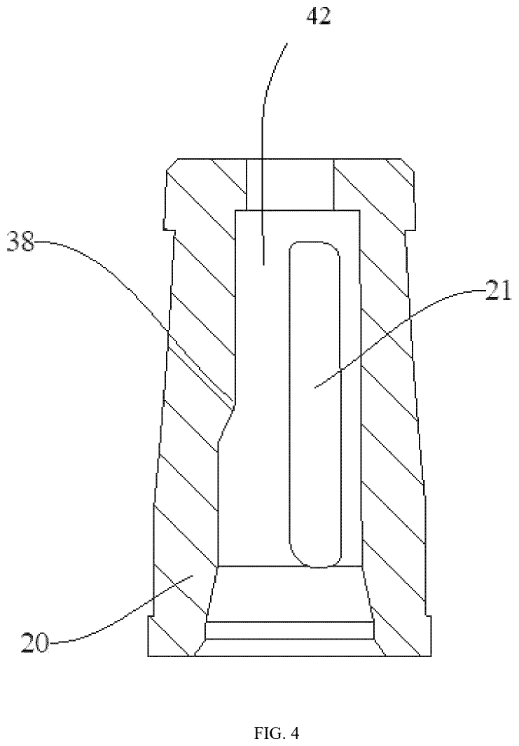

As shown in FIGS. 2 and 4, in the embodiment of the present application, a circumferential side wall of the limiting bracket 20 is provided with an assembly through groove 21 communicated with the internal through hole, the mounting structure further includes an elastic arm 22 located in the assembly through groove 21 and dividing the assembly through groove 21 into two parts, the elastic arm 22 extends in a direction parallel to an axial direction of the internal through hole, and the elastic arm 22 is configured to be deformable in a radial direction of the internal through hole.

With the above arrangement, only both ends of the elastic arm 22 are connected with an inner wall of the assembly through groove 21, and the rest of the elastic arm 22 is suspended in the assembly through groove 21 to cause the elastic arm 22 to generate a certain elastic effect, such that the vibration can be effectively reduced during vibrating of the power output shaft, and the problem of abrasion or an abnormal sound caused by plastic fatigue generated by long-term pressing in use can be reduced.

Preferably, in the embodiment of the present application, the clamping groove is an annular groove arranged around the axis of the power output shaft. Thus, the clamping protrusion 322 and the clamping groove are fitted conveniently, and precision of assembly of the clamping groove and the clamping protrusion 322 in the circumferential direction of the power output shaft does not need to be considered.

Preferably, in the embodiment of the present application, an included angle between the connecting arm 321 and the clamping protrusion 322 is greater than or equal to 45 degrees and less than or equal to 90 degrees.

As shown in FIGS. 1 and 5, in the embodiment of the present application, the nursing head further includes a limiting groove 33 arranged in an inner wall of the mounting through hole 12 and a limiting rib 34 arranged on the quick detachment bracket 30, the limiting groove 33 is arranged around an axis of the mounting through hole 12, and the limiting rib 34 is in limiting fit with the limiting groove 33.

With the above arrangement, when the quick detachment bracket 30 is mounted in the mounting through hole 12, the limiting fit between the limiting rib 34 and the limiting groove 33 can limit a displacement of the quick detachment bracket 30 in an axial direction of the mounting through hole 12, such that axial limiting between the quick detachment bracket and the mounting through hole 12 is realized, and thus, when power is transmitted by the mounting structure or the nursing head is placed as an independent accessory, axial movement of the mounting structure can be avoided, thereby improving the experience of the user.

Preferably, in the embodiment of the present application, the nursing head includes a plurality of limiting grooves 33 and a plurality of limiting ribs 34 correspondingly fitted with the plurality of limiting grooves 33, and the plurality of limiting grooves 33 are arranged at intervals around the axis of the mounting through hole 12, so as to improve an axial movement preventing effect.

In an embodiment, the limiting groove 33 may also be a circumferentially extending closed-loop annular groove.

As shown in FIGS. 1 and 5, in the embodiment of the present application, a transition part having an arc-shaped curved surface protruding towards the side where the axis of the mounting through hole 12 is located is provided at a junction of the side wall of the limiting groove 33 and the inner wall of the mounting through hole 12, so as to smoothly connect the side wall of the limiting groove 33 and the inner wall of the mounting through hole 12. Thus, the quick detachment bracket 30 can be conveniently mounted by utilizing elastic deformation of transition, such that the limiting rib 34 can slide into the limiting groove 33, the transition part can limit the limiting rib 34, and it is avoided that the quick detachment bracket 30 is separated from the mounting through hole 12 due to a gravity influence.

Preferably, the arc-shaped curved surface of the transition part may have a radius of 0.1 mm. Certainly, other sizes are possible, as long as the transition part is ensured to have the above-described functions.

Preferably, in the embodiment of the present application, the irrigation-brushing handle 10 is made of plastic, or the like, and the quick detachment bracket 30 is made of polyformaldehyde (POM), or the like, such that rigidity and strength of the quick detachment bracket 30 are greater than rigidity and strength of the irrigation-brushing handle 10, and the irrigation-brushing handle 10 can also be slightly elastically deformed when the quick detachment bracket 30 is mounted, thereby facilitating mounting of the quick detachment bracket 30 in the mounting through hole 12.

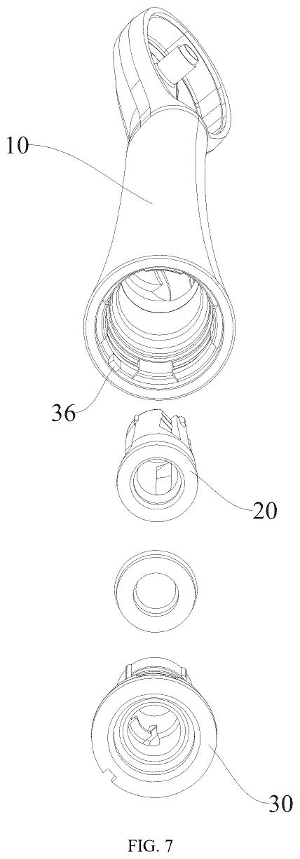

As shown in FIGS. 5 and 7, in the embodiment of the present application, the nursing head further includes a directional groove 35 and a directional rib 36 fitted with the directional groove 35, the directional groove 35 is arranged in the quick detachment bracket 30, and the directional rib 36 is arranged on the inner wall of the mounting through hole 12.

With the above arrangement, on the one hand, the directional rib 36 can be used as a reference to realize directional mounting of the mounting structure and the power output shaft, such that the mounting structure and the power output shaft can be prevented from being inverted, and correct assembly between the mounting structure and the power output shaft is ensured; on the other hand, circumferential positioning of the quick detachment bracket 30 can be realized by the fit between the directional groove 35 and the directional rib 36, such that relative rotation between the quick detachment bracket 30 and the power output shaft is prevented, and mounting of the mounting structure is more stable.

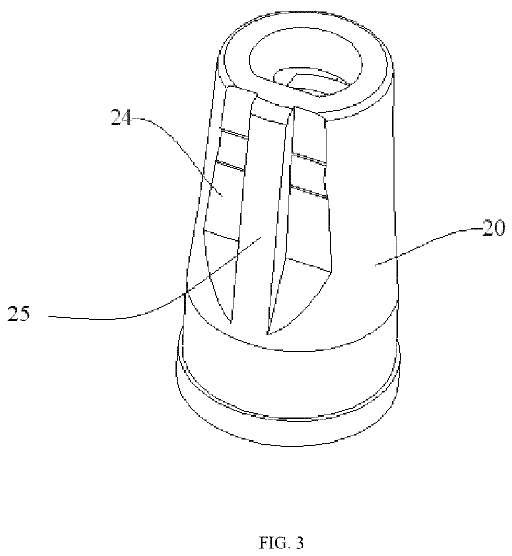

As shown in FIGS. 1 and 3, in the embodiment of the present application, the nursing head further includes two rotation stopping ribs 23 located in the mounting through hole 12 and connected with the inner wall of the mounting through hole 12, and the two rotation stopping ribs 23 are spaced apart along a circumferential direction of the mounting through hole 12; along the circumferential direction of the mounting through hole 12, two rotation stopping grooves 24 are spaced apart in the limiting bracket 20, a spacing structure between the two rotation stopping grooves 24 forms a first convex rib 25, and the first convex rib is inserted between the two rotation stopping ribs 23.

With the above arrangement, a groove may be formed between the two rotation stopping ribs 23 spaced apart, and the first convex rib between the two rotation stopping grooves 24 spaced apart can be inserted into the groove, such that rotation of the limiting bracket 20 relative to the irrigation-brushing handle 10 can be limited, and therefore, in the process that the power output shaft drives the limiting bracket 20 to rotate, the irrigation-brushing handle 10 in limiting fit with the limiting bracket 20 can be driven, and then, the limiting bracket 20 can transmit the swing force of the power output shaft to the irrigation-brushing handle 10, so as to achieve the tooth cleaning function of the electric toothbrush through the vibration of the sound wave motor.

Further, the rotation stopping groove 24 is in limiting fit with the rotation stopping rib 23, and a fool-proof effect can be achieved, such that the limiting bracket 20 and the power output shaft can be mounted in a forward direction, and a swing direction of the power output shaft is consistent with that of the brush head.

As shown in FIG. 4, in the embodiment of the present application, a positioning groove is arranged in a circumferential side of the power output shaft, a positioning convex rib 38 is arranged on an inner wall of the internal through hole, the positioning convex rib 38 is connected with the limiting bracket 20, and the positioning convex rib 38 is fitted with the positioning groove.

With the above arrangement, on the one hand, the positioning convex rib 38 is fitted with the positioning groove to limit rotation of the power output shaft relative to the limiting bracket 20, such that a vibration force of the power output shaft can be transmitted to the limiting bracket 20 and transmitted to the irrigation-brushing handle 10 through the limiting bracket 20, and the oral nursing device has the tooth brushing function of the electric toothbrush; on the other hand, when the power output shaft is mounted, the positioning convex rib 38 can guide the power output shaft, such that the fool-proof effect is achieved, thereby avoiding inverse mounting of the power output shaft.

It should be noted that the oral nursing device according to the present embodiment has the advantages of simple assembly and disassembly, and low manufacturing and assembly costs.

From the above description, it can be seen that the above-described embodiments of the present application achieve the following technical effects: the power output shaft penetrates through the assembly through hole, the circumferential side wall of the quick detachment bracket is provided with the avoiding groove communicated with the assembly through hole, the clamping member is located in the avoiding groove, the connecting end of the clamping member is connected with the quick detachment bracket, the free end of the clamping member extends into the assembly through hole through the avoiding groove and is in clamping fit with the clamping groove in the power output shaft, and thus, one end of the clamping member is connected with the quick detachment bracket, and the rest of the clamping member is suspended in the avoiding groove and the assembly through hole, such that the clamping member can have a certain deformation capacity to generate the elastic effect, and therefore, when the power output shaft is inserted into the assembly through hole of the quick detachment bracket, the clamping member can be elastically deformed until the free end of the clamping member is clamped into the clamping groove in the power output shaft, and the clamping member is recovered from deformation, thereby realizing rapid mounting of the nursing head and the power output shaft; similarly, since the clamping member can have a certain elastic deformation capacity, when the user disassembles the nursing head, the clamping member can be elastically deformed to be separated from the clamping groove in the power output shaft, such that the user can remove the nursing head by gripping the handle portion to directly pull out the power output shaft, thereby realizing the rapid disassembly of the nursing head to improve the use experience of the user.

The above description is only preferred embodiments of the present application and is not intended to limit the present application, and various modifications and changes may be made to the present application by those skilled in the art. Any modification, equivalent replacement, or improvement made within the spirit and principle of the present application shall be included in the protection scope of the present application.

What is claimed is:

1. An oral nursing device, comprising a handle portion (01) and a nursing head (02), the handle portion being configured to be gripped, the handle portion comprising:
a motor (50) comprising a motor body (51) and a power output shaft (52), the power output shaft being configured to be fitted with the motor body and transmit output power of the motor body, an axial passage (522) extending along an axis (521) of the power output shaft being arranged on the power output shaft, and a clamping groove (523) being arranged in a circumferential side wall of the power output shaft;
the nursing head comprising:
an irrigation-brushing handle (10) provided with a fluid passage (11) extending along the axis of the power output shaft and a mounting through hole (12) communicated with the fluid passage (11), the axial passage being communicated with the fluid passage (11), and the mounting through hole (12) being located at a first end of the irrigation-brushing handle (10);
a brush head (40) arranged at a second end of the irrigation-brushing handle (10), the brush head comprising bristles (13) and a spray head (14), a direction of a nozzle of the spray head (14) being the same as that of the bristles (13), and the spray head (14) being communicated with the fluid passage (11);
a mounting structure (41) located in the mounting through hole (12) and in limiting fit with the mounting through hole (12), the mounting structure comprising a limiting bracket (20) with an internal through hole (42) and a quick detachment bracket (30) in sealing connection with the limiting bracket (20), the quick detachment bracket (30) being located on a side of the limiting bracket (20) opposite to the brush head, the quick detachment bracket (30) being provided with an assembly through hole (39) communicated with the internal through hole, the internal through hole being in rotation stopping fit with the power output shaft, the power output shaft penetrating through the assembly through hole (39), an avoiding groove (31) communicated with the assembly through hole (39) being provided in a circumferential side wall of the quick detachment bracket (30), the mounting structure further comprising a clamping member (32) located in the avoiding groove (31), a connecting end of the clamping member (32) being connected with the quick detachment bracket (30), and a free end of the clamping member (32) extending into the assembly through hole (39) through the avoiding groove (31) and being in clamping fit with the clamping groove in the power output shaft.

2. The oral nursing device according to claim 1, wherein the clamping member (32) comprises a connecting arm (321) and a clamping protrusion (322) which are connected and arranged at an included angle, the connecting arm (321) extends in a direction parallel to the power output shaft, the clamping protrusion (322) protrudes in a direction of an axis of the assembly through hole (39), an end of the connecting arm (321) away from the clamping protrusion (322) forms the connecting end, and an end of the clamping protrusion (322) away from the connecting arm (321) forms the free end.

3. The oral nursing device according to claim 2, wherein a first guide surface (323) is obliquely arranged on the clamping protrusion (322), the first guide surface (323) is located on a side of the clamping protrusion (322) opposite to the connecting end, and along an axial direction of the power output shaft, a distance between the first guide surface (323) and the axis of the assembly through hole (39) is gradually reduced from an end of the quick detachment bracket (30) away from the limiting bracket (20) to an end of the quick detachment bracket (30) close to the limiting bracket (20).

4. The oral nursing device according to claim 2, wherein a second guide surface (324) is obliquely arranged on the clamping protrusion (322), the second guide surface (324) is located on a side of the clamping protrusion (322) facing the connecting end, and along the axial direction of the power output shaft, a distance between the second guide surface (324) and the axis of the assembly through hole (39) is gradually increased from the end of the quick detachment bracket (30) away from the limiting bracket (20) to the end of the quick detachment bracket (30) close to the limiting bracket (20).

5. The oral nursing device according to claim 1, wherein a circumferential side wall of the limiting bracket (20) is provided with an assembly through groove (21) communicated with the internal through hole, the mounting structure further comprises an elastic arm (22) located in the assembly through groove (21) and dividing the assembly through groove (21) into two parts, the elastic arm (22) extends in a direction parallel to an axial direction of the internal through hole, and the elastic arm (22) is configured to be deformable in a radial direction of the internal through hole.

6. The oral nursing device according to claim 2, wherein the clamping groove is an annular groove arranged around the axis of the power output shaft; or an included angle between the connecting arm (321) and the clamping protrusion (322) is greater than or equal to 45 degrees and less than or equal to 90 degrees.

7. The oral nursing device according to claim 1, wherein the nursing head further comprises a limiting groove (33) arranged in an inner wall of the mounting through hole (12) and a limiting rib (34) arranged on the quick detachment bracket (30), the limiting groove (33) is arranged around an axis of the mounting through hole (12), and the limiting rib (34) is in limiting fit with the limiting groove (33).

8. The oral nursing device according to claim 1, wherein the nursing head further comprises a directional groove (35) and a directional rib (36) fitted with the directional groove (35), the directional groove (35) is arranged in one of the inner wall of the mounting through hole (12) and the quick detachment bracket (30), and the directional rib (36) is arranged on the other of the inner wall of the mounting through hole (12) and the quick detachment bracket (30).

9. The oral nursing device according to claim 1, wherein the nursing head further comprises two rotation stopping ribs (23) located in the mounting through hole (12) and connected with the inner wall of the mounting through hole (12), and the two rotation stopping ribs (23) are spaced apart along a circumferential direction of the mounting through hole (12);
along the circumferential direction of the mounting through hole (12), two rotation stopping grooves (24) are spaced apart in the limiting bracket (20), a spacing structure between the two rotation stopping grooves (24) forms a convex rib (25), and the convex rib is inserted between the two rotation stopping ribs (23).

10. The oral nursing device according to claim 1, wherein a positioning groove is arranged in a circumferential side of the power output shaft, a positioning convex rib (38) is arranged on an inner wall of the internal through hole, the positioning convex rib (38) is connected with the limiting bracket (20), and the positioning convex rib (38) is fitted with the positioning groove.
